(19) United States
(12) Patent Application Publication
(10) Pub. No.: US 2015/0177147 A1
(43) Pub. Date: Jun. 25, 2015

(54) Biological Fluid Analysis System and Method

(71) Applicants: Steven L. Mangan, Gananoque (CA); Gary Jonas, Queensville (CA)

(72) Inventors: Steven L. Mangan, Gananoque (CA); Gary Jonas, Queensville (CA)

(73) Assignee: DAIRY QUALITY INC., Queensville, ON (CA)

(21) Appl. No.: 14/406,103

(22) PCT Filed: Jun. 5, 2012
(86) PCT No.: PCT/CA2012/000549

§ 371 Date: Dec. 5, 2014

(51) Int. Cl. G01N 21/64; G06K 9/00

(52) U.S. Cl. CPC G01N 21/6428; G06K 9/0014; G06K 9/00134; G01N 2201/068

(57) ABSTRACT

A biological fluid analysis system and method for measuring optical characteristics of a sample of biological fluid using a commercially available portable computing device having a camera, such as a smart phone. The system includes a scope, a case that attaches to the portable computing device, and a software application that runs on the portable computing device. Some embodiments of the invention include a sample slide having a viewing chamber that can be filled with a biological fluid to be analyzed by the biological fluid analysis system. The system may be adapted to analyze cow's milk to estimate the number of somatic cells per unit volume contained in the milk using a reagent that stains the somatic cells so that they will fluoresce when excited by light with a particular wavelength, with the light source in the scope being adapted to generate light of that particular wavelength.

### FIELD OF THE INVENTION

The present invention relates generally to systems and methods for measuring optical characteristics of a sample of biological fluid, and more particularly to systems and methods for measuring optical characteristics of a sample of biological fluid using a commercially available portable computing device having a camera.

### BACKGROUND OF THE INVENTION

Biological fluid, such as blood, milk, urine and sap, or other liquid containing biological entities, may, either by itself, or when processed, for example to mix it with a particular reagent, have optical characteristics the measurement (estimation) of which may provide valuable information, such as an indication of the health of the biological entity from which the biological fluid was obtained. An optical characteristic means a characteristic that can be measured in an optical image or photograph of a sample of the biological fluid when the sample is illuminated by a light source and optionally magnified. Examples include estimates of the density of the fluid, the optical transmittance of the fluid at a particular wavelength, and the number of cells present in the sample stained by mixing the sample with a reagent (such as propidium iodide or ethidium bromide).

An important example of the use of measuring such optical characteristics is the measurement of the number of somatic cells in a sample of milk, which is widely used as an indicator of mastitis infection and udder health of the animal from which the milk sample was obtained. Somatic cells in cow's milk typically consist of about 75% leukocytes or white blood cells, which include macrophages, lymphocytes, and polymorphonuclear neutrophils (PMN), and about 25% epithelial cells. Macrophages are the predominant cell type in normal milk, and constitute about 30 to 74% of the total cells in milk from uninfected glands. Mastitis is an inflammatory response to bacteria in the mammary gland, the presence of which results in increased numbers of phagocytic cells (macrophages and PMN), which are adapted to kill bacteria, in the milk.

For dairy cattle, a somatic cell count (SCC) of about 29,000 per ml is about average, and an SCC over 200,000 per ml is generally considered to be an indication of the existence of mastitis, although levels of 50,000 per ml may indicate the need for closer observation. For human consumption, a generally accepted limit is an SCC of 750,000 per ml.

SCC estimation can be done by direct microscopic analysis, but this requires well-trained personnel and is slow and costly. Many automated electronic SCC systems have been developed but they are very expensive, and generally require sending a milk sample to a central lab, which means that it takes a significant amount of time (generally several days or a week) to get the test results, and the cost per test is relatively high (e.g. $10 per test). Although some smaller but generally non-portable testing devices have been developed by companies such as DeLaval, so that it may be feasible for a dairy farmer to purchase an SCC analyzer for use at the farm, these systems include relatively expensive custom analyzers that cost several thousand dollars.

### SUMMARY OF THE INVENTION

The present invention provides a biological fluid analysis system for measuring optical characteristics of a biological fluid using a portable computing device having a camera, the camera having a lens, a sample of biological fluid being contained in a transparent viewing chamber in a sample slide, the system comprising:
(a) a scope comprising:
   (i) an imaging tube having proximal and distal ends and having a slide holder adapted to receive the sample slide so that the viewing chamber is maintained inside the imaging tube, the imaging tube defining a light path between the viewing chamber and a viewing opening in the proximal end of the imaging tube;
   (ii) a light source adapted to illuminate the sample of biological fluid in the viewing chamber when the sample slide is in the slide holder;
   (iii) a lens system disposed inside the imaging tube, positioned to receive light reflected or transmitted along the light path by the sample of biological fluid contained in the viewing chamber, and adapted to present a magnified image of a portion of the sample of biological fluid at the viewing opening; and
   (iv) a case connector;
(b) a case for attaching to the portable computing device, the case comprising a lens opening positioned to expose the camera lens when the case is attached to the portable computing device, and comprising a scope connector adapted to mate with the case connector on the scope to maintain the scope in a fixed position relative to the portable computing device so that the magnified image at the viewing opening is presented to the camera lens through the lens opening; and
(c) a software application adapted to run on the portable computing device and adapted to analyze a photograph of the magnified image taken by the camera to determine at least one optical characteristic of the sample.

The scope connector may surround the lens opening.

The case connector may be at the proximal end of the imaging tube, and the scope connector and case connector may have circular cross-sections. The scope connector and case connector may be threaded.

The software application may be adapted to control the camera and to take the photograph of the magnified image in response to user input.

The software application, after taking the photograph, may automatically analyze the photograph and display the at least one optical characteristic of the sample to the user.

The slide holder may be a slot in the imaging tube oriented perpendicularly with respect to the light path.

The system may also include the sample slide.

The target cells in the biological fluid may be optically distinct from the remainder of the biological fluid, and the software application may use image processing techniques to estimate the number of target cells in the magnified image. The image processing techniques may comprise: (a) establishing a threshold for the pixel values so that pixels have a value greater than the threshold are considered to be cell pixels that are part of a somatic cell; (b) identifying and counting the number of cell pixels in the perimeter of each set of connected cell pixels; (c) counting each set of connected cell pixels as one or more target cells based on the length of the perimeter of the set of connected cell pixels wherein a set of connected cell pixels having a perimeter length less than a predetermined number of pixels is not counted as a target cell.

The software application may estimate the number of target cells per unit volume of biological fluid based on an estimate of the volume of biological fluid imaged in the magnified image.

The biological fluid may be milk, and the viewing chamber may contain the sample of milk mixed with a reagent that causes somatic cells contained in the sample to fluoresce when excited by light with a particular wavelength, and the light source may be adapted to generate light of that particular wavelength. The reagent may be propidium iodide and the particular wavelength may be in the range of 500 nm to 570 nm. The particular wavelength may preferably be about 535 nm.

The optical characteristic measured by the system may be an estimated number of somatic cells in the magnified image of the imaged portion of the milk sample. The software application may estimate the number of somatic cells per unit volume based on an estimate of the volume of milk imaged in the magnified image. The software application may estimate the number of somatic cells by counting the number of stained regions in the photograph of the magnified image of the milk sample using image processing techniques.

The light source may be attached to the tube near the distal end inside the tube and the slide holder may be located between the light source and the lens system.

The lens system may comprise an ocular lens mounted in the imaging tube towards the proximal end of the imaging tube, and an objective lens mounted in the imaging tube between the viewing chamber and the ocular lens so that the viewing chamber is in a focal plane of the objective lens.

The magnified image may be magnified by a factor of at least 200.

The invention further provides a method, performed by a user using the biological fluid analysis system, of measuring optical characteristics of the biological fluid, the sample of biological fluid being contained in the transparent viewing chamber in the sample slide, the portable computing device having the software application installed thereon and the case attached thereto, the method comprising the steps of:
(a) attaching the scope to the case by mating the case connector and the scope connector and placing the sample slide in the slide holder in the imaging tube of the scope;
(b) taking a photograph of the magnified image using the camera of the portable computing device; and
(c) running the software application on the portable computing device and instructing the software application to analyze the photograph to determine at least one optical characteristic of the sample.

The invention further provides a method, performed by a user using the biological fluid analysis system, of measuring optical characteristics of the biological fluid, the portable computing device having the software application installed thereon and the case attached thereto, the method comprising the steps of:
(a) mixing the biological fluid with a reagent;
(b) placing the mixture into the viewing chamber of the sample slide;
(c) attaching the scope to the case by mating the case connector and the scope connector and placing the sample slide in the slide holder in the imaging tube of the scope;
(d) taking a photograph of the magnified image using the camera of the portable computing device; and
(e) running the software application on the portable computing device and instructing the software application to analyze the photograph to determine at least one optical characteristic of the sample.

The invention further provides a sample slide comprising:
(a) a sample reception chamber for receiving and holding a pre-determined volume of a sample of fluid;
(b) a mixing chamber having a volume greater than the pre-determined volume to permit the sample to be mixed in the mixing chamber;
(c) a first channel connecting the sample reception chamber to the mixing chamber, and a first valve moveable between open and closed positions, wherein when the first valve is in the closed position fluid flow between the sample reception chamber and the mixing chamber is blocked, and in the open position the sample reception chamber is in fluid communication with the mixing chamber so that the pre-determined volume of the sample of fluid flows from the sample reception chamber to the mixing chamber;
(d) a transparent viewing chamber; and
(e) a second channel connecting the mixing chamber to the viewing chamber, and a second valve moveable between open and closed positions, wherein when the second valve is in the closed position fluid flow between the mixing chamber and the viewing chamber is blocked, and in the open position the mixing chamber is in fluid communication with the viewing chamber so that the mixed sample flows from the mixing chamber to the viewing chamber.

The mixing chamber may be preloaded with a volume of reagent, and the volume of the mixing chamber is greater than the sum of the pre-determined volume and the volume of the reagent to permit the reagent and sample to be mixed in the mixing chamber.

The sample slide may comprise a hollow vertical cylinder having an upper portion being the sample reception chamber, and a middle portion below the sample reception chamber being the mixing chamber, where the mixing chamber is above the viewing chamber.

The first valve may be a first cylindrical slider disposed in the vertical cylinder between the sample reception chamber and the mixing chamber, and the first slider may be initially positioned in the closed position in which it blocks an upper opening of the first channel to the sample reception chamber and the first slider may be slideable downward in the vertical cylinder under control of a user, so that the user may move the first slider to the open position by sliding the first slider downward to expose the upper opening of the first channel to the sample reception chamber.

The first slider may be held in the initial closed position by frictional engagement with the vertical cylinder.

The second valve may be a second cylindrical slider disposed in the vertical cylinder between the mixing chamber and the viewing chamber, wherein the second slider is initially positioned in the closed position in which it blocks an upper opening of the second channel to the mixing chamber and the second slider is slideable downward in the vertical cylinder under control of a user, so that the user may move the second slider to the open position by sliding the second slider downward to expose the upper opening of the second channel to the mixing chamber.

The first channel may be sufficiently narrow that, when the first valve is in the open position, fluid is drawn into the first channel by capillary action.

The second channel may be sufficiently narrow that, when the second valve is in the open position, fluid is drawn into the second channel by capillary action.

The second channel may be sufficiently narrow that surface tension prevents fluid in the viewing chamber from re-entering the second channel.

The first channel may be no more than 2 mm in diameter. The first channel may preferably be no more than 1 mm in diameter.

The second channel may be no more than 2 mm in diameter. The second channel may preferably be no more than 1 mm in diameter.

The sample slide may further comprise an additional first channel and an additional second channel that operate in the same manner as the first and second channels respectively.

### BRIEF DESCRIPTION OF THE DRAWINGS

FIG. 1 is a perspective view of an embodiment of the invention attached to a portable computing device that is a smart phone.

FIG. 2 shows an embodiment of a case separated from a smart phone to which it attaches.

FIG. 3 is a rear plan view of an embodiment of the case showing the lens opening in the case and scope connector surrounding the lens opening.

FIG. 4 is a side view of an embodiment of a scope showing the light path.

FIG. 5 is a cross-sectional view through the scope of FIG. 4 with a slide inserted into the slot in the scope and the scope connected to a case attached to a smart phone.

FIG. 6 is a perspective view of another embodiment of a scope.

FIG. 7 is a side view of the scope of FIG. 6 connected to a case and with a slide inserted in the slot in the scope.

FIG. 8 is a front plan view of a sample slide.

FIG. 9 is a side cross-sectional view of the slide of FIG. 8.

FIG. 10 is an exploded view of the slide of FIG. 8.

FIG. 11 is another front plan view of the slide of FIG. 8 showing the internal structure.

FIG. 12 is an example of a photograph of an image of a sample of fluid taken by a mobile device using the invention.

### DETAILED DESCRIPTION OF THE INVENTION

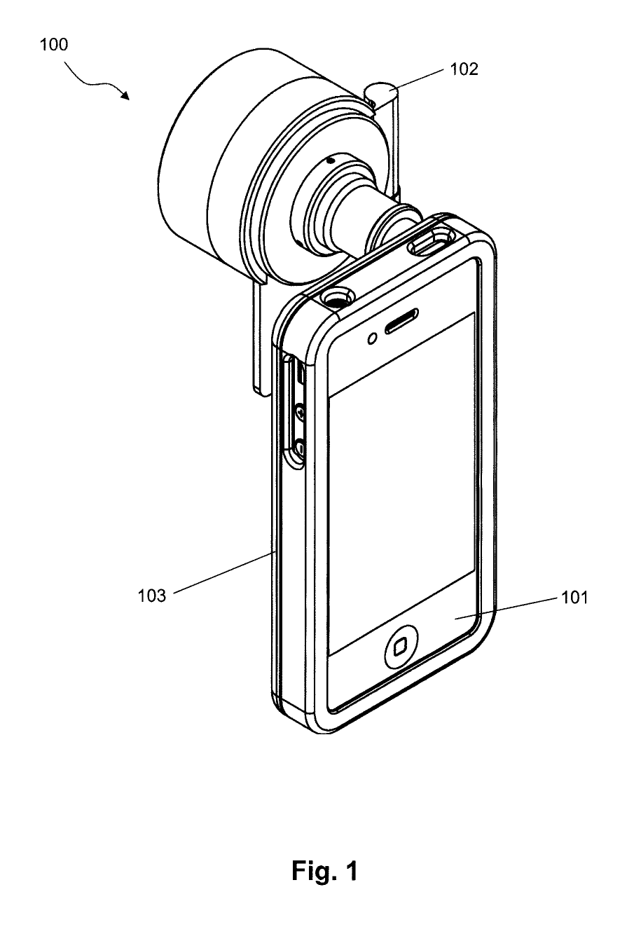

One embodiment of the invention is shown in FIG. 1. The invention comprises a biological fluid analysis system and associated method for measuring optical characteristics of a biological fluid using a portable computing device 101, such as a smart phone, that has a camera. The system includes (1) a scope 100, (2) a case 103 that attaches to the portable computing device 101, and (3) a software application that runs on the portable computing device 101. Some embodiments of the invention include a sample slide 102 having a viewing chamber that can be filled with a biological fluid, which may have been mixed with a reagent. The analysis system analyzes the biological fluid in a sample slide to determine one or more optical characteristics of the sample, such as how many somatic cells per unit volume are present in the sample.

The portable computing device 101 is typically a mobile device, such as a smart phone or tablet computer, having a camera with a lens for taking photographs, a screen (or display) for displaying images and text to the user of the device, and a computer processor programmable by software that can control the camera and process photographs, or images, taken by the camera. The device also generally has a means for the user to provide input, including text, such as a physical keyboard, or a touch screen that supports a virtual keyboard displayed on the device's screen or other control buttons. The keyboard may be a full keyboard or a reduced keyboard (such as 10 keys numbered 0 to 9 where each is associated with up to three characters, for example). Examples of such a mobile device include, for example, an iPhone™, an iPad™, a Galaxy Nexus™, a BlackBerry Curve™, and an HTC Rezound™. The device has a programmable computer processor for running software applications, or “apps”, which are coded in a suitable language, such as C, and compiled to produce executable software applications for running on the processor. The device may also have a wireless interface that allows it to communicate, and exchange data, with other computing devices over a phone network and/or the internet.

The portable computing device 101 is not part of the invention and is generally a widely available commercial off-the-shelf product. These are generally relatively very low cost as compared to a custom-designed analyzer for analyzing photographic images. In general they include a CCD, or more commonly a CMOS, sensor that produces an image of 640×480 pixels or greater, and preferably 1280×1024 or 1600×1200 or greater. The required resolution may vary based on the application, but, for example, for counting somatic cells in milk a 1280×1024 pixel image using, for example, a 200-400× magnification of the sample to provide about a five micron resolution is sufficient. The magnification is selected so that sufficient resolution is provided in the resulting photograph so that somatic cells can be resolved and their size measured by analyzing the photograph.

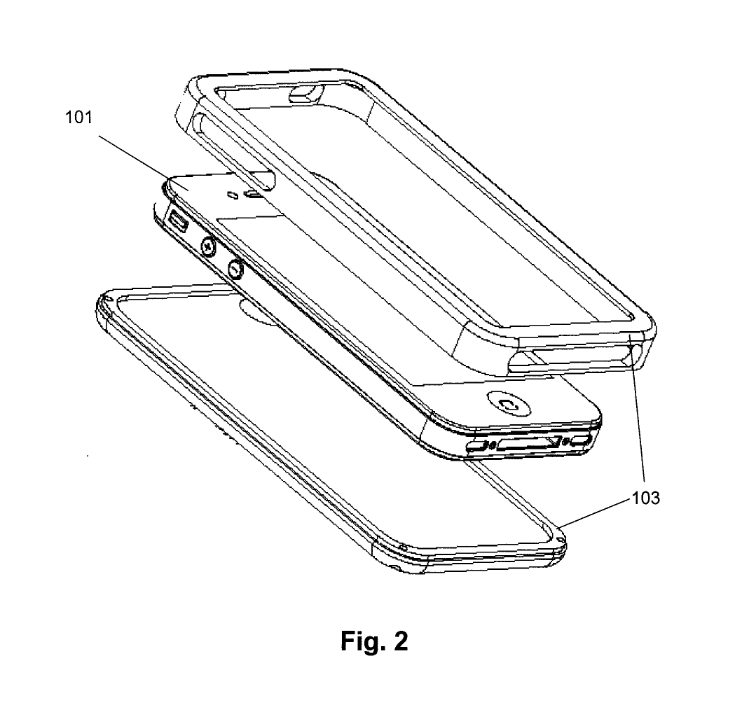

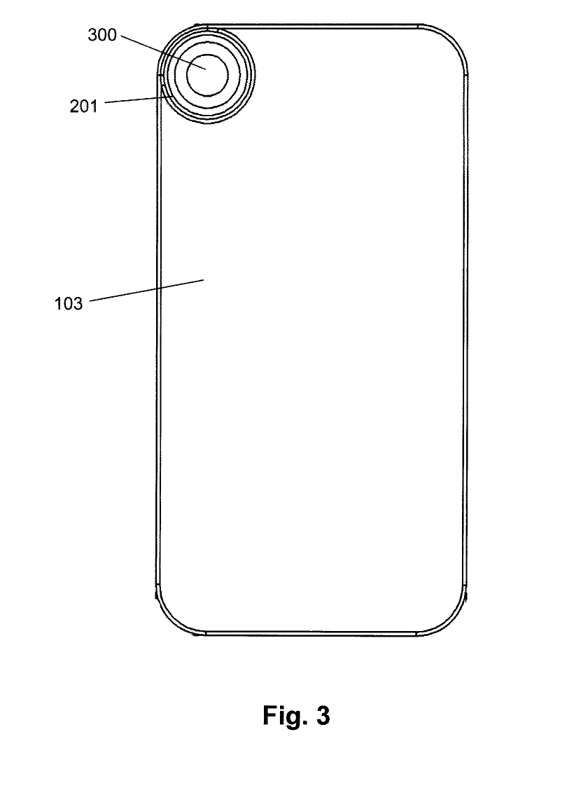

The invention includes a case 103 that is designed to fit a particular type or class of portable computing device. E.g. one type of case 103 may be designed to fit an iPhone™ 4S smart phone. FIGS. 2 and 3 also show the case 103 having a cylindrical scope connector 201 that is used to connect the case 103 to a scope 100. The case 103 is designed to connect firmly to the device 101 and has a lens opening 300, as shown in FIG. 3, positioned to expose the camera lens when the case 103 is attached to the portable computing device 101. The lens opening 300 is preferably circular and, when the case 103 is attached to the device 101, the edge of the lens opening 300 surrounds the camera lens so that the lens is approximately centered in the opening 300.

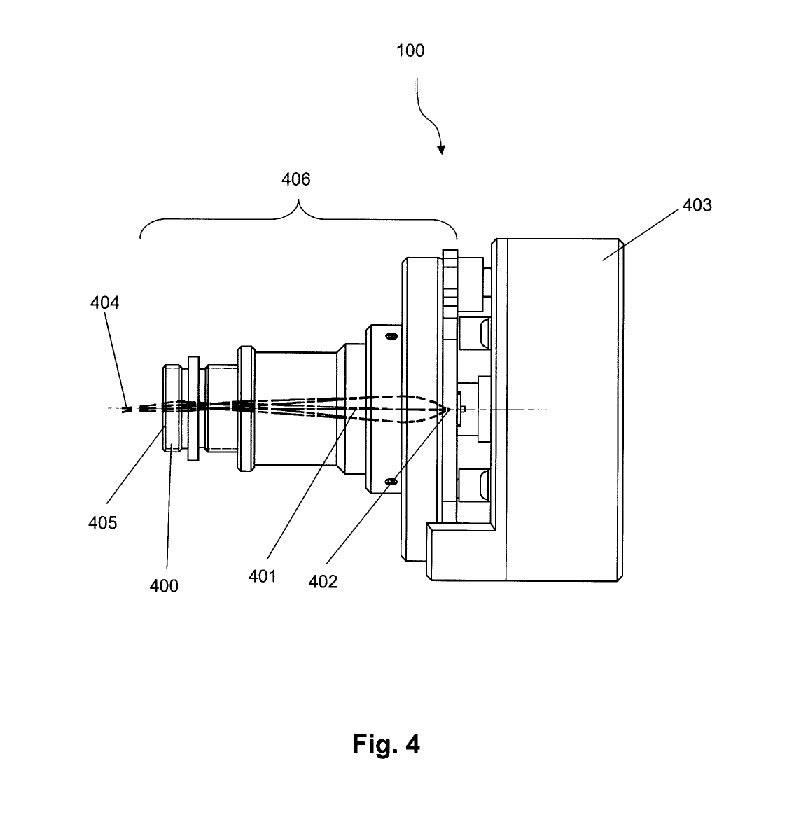

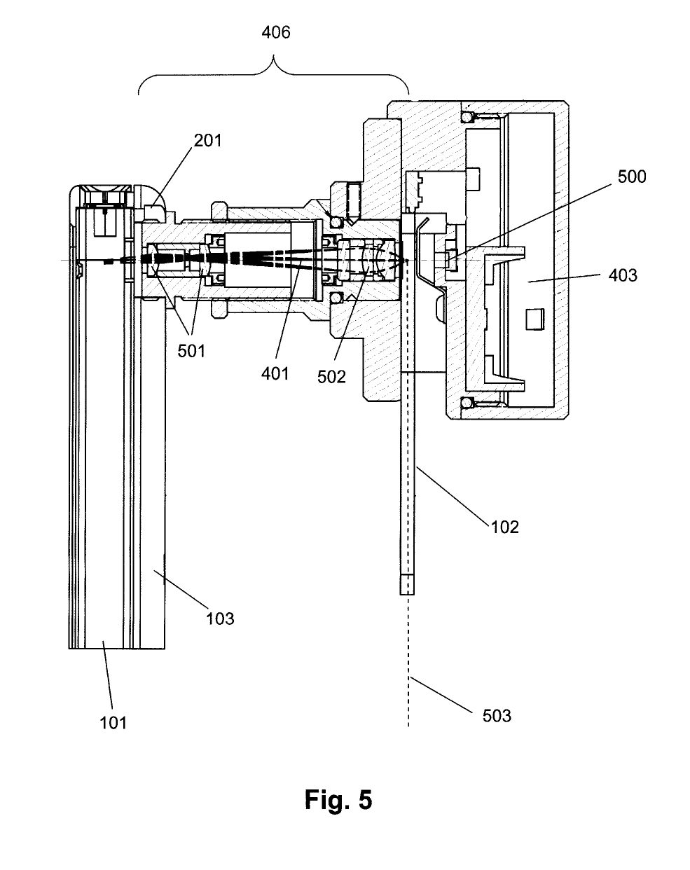

The case 103 includes a scope connector 201 that is designed to connect to, or mate with, a case connector 400 on the scope 100 to maintain the scope 100 in a fixed position relative to the portable computing device 101 so that the magnified image 404 at the viewing opening 405 at the proximal end of the imaging tube 406 is presented to the camera lens through the lens opening 300. A case connector 400 is shown in FIG. 4, and FIGS. 5 and 7 show a case connector 201 mated with a scope connector. In preferred embodiments, the scope connector 201 has a circular cross section in the plane parallel to the side (generally the back) of the device 101 having the camera lens, and is integrally formed with the edge of the lens opening 300 or surrounds the lens opening 300. For example, it may comprise a cylindrical section, having a central axis perpendicular to the back of the mobile device 101 and the camera lens, that provides either a threaded connector or a bayonet mount similar to the types of connectors employed by SLR camera bodies for use in mounting lenses. However, any type of scope connector that permits the scope 100 to be rigidly connected to the case 103 so that the magnified image 404 produced by the scope 100 is presented to the camera lens may be employed. Other than the scope mount 201 and lens opening 300, the case may be generally similar to commercially available off-the-shelf mobile device cases that typically surround the entire phone other than the camera lens or lenses, display, keyboard (if any), and microphone, speaker and other openings. It does not need to have two parts as depicted in FIG. 2, and may be a single piece into which the device 101 is placed or slide into. However any case is suitable that is adapted to provide a suitable stable scope mount 201 so that the magnified image 404 produced by the scope 100 is presented to the camera lens when the scope 100 is attached to the case 103 and held steady relative to the camera lens.

FIG. 4 shows a side view of the scope 100 of FIG. 1 in isolation. The depicted embodiment comprises a rear portion 403 that may house a power source, such as a battery, and an imaging tube 406 defining a light path 401 between the viewing chamber 402 and a viewing opening 405 in the proximal end of the imaging tube 406. Towards the distal end, the imaging tube 406 has a slot, which may be oriented perpendicularly with respect to the light path, for insertion of a sample slide having a viewing chamber 402 so that the viewing chamber 402 of the sample slide may be positioned at the focal plane 503 (shown in FIG. 5) of the objective lens 502 of the scope 100.

Note that the light path 401, although depicted in FIG. 4 on the outside of the imaging tube 406, runs along the central longitudinal axis of the imaging tube 406 in the centre of the imaging tube 406. The imaging tube 406 may be cylindrical, with varying diameter as shown in FIG. 4 to accommodate the lens system housed therein comprising cylindrical lenses, and defines the light path 401 by its central longitudinal axis.

When the sample in the viewing chamber 402 is illuminated, light reflected from the sample or transmitted by the sample along the light path may be magnified by the lens system disposed within the imaging tube 406 to create a magnified image 404 of a portion of the sample of biological fluid at (near) the viewing opening 405 so that the magnified image 404 is presented to the camera lens of the mobile device 101 when a case is attached to the device 101 and the scope 100 is attached to the case. In the preferred embodiment shown in FIG. 4, the case connector 400 is formed from a portion of the cylindrical imaging tube 406, near the proximal end of the imaging tube 406, having threads on the outside for mating with a threaded scope connector 201.

A preferred embodiment of a scope 100, suitable for counting somatic cells in milk, is adapted to be able to resolve circular objects of 1-10 microns in diameter with a field size of at least 100 microns. This may require magnifying the sample by about 400 times. The length of the scope 100 may be about 75 mm or less.

FIG. 5 is a cross section through the scope 100 of FIG. 4 through the longitudinal axis of the imaging tube 406 along which the light path 401 passes, with a slide 102 inserted in the scope 100, and the scope 100 connected to a smart phone 101 via a case 103. The scope 100 may include a light source 500 that may be placed behind the position of the viewing chamber 402 when it is positioned in the slide slot of the scope 100. FIG. 5 shows a slide 102 inserted in the slot in the scope 100 so that the viewing chamber is placed in the focal plane 503 of the scope between the light source 500 and an objective lens 502 disposed within the imaging tube 406. There is also an ocular lens, or lens system, 501 disposed within the imaging tube 406 near the proximal end that causes a magnified image 404 to be formed from light passing through the viewing chamber 402 and through the objective lens 502 positioned between the viewing chamber 402 and the ocular lens.

A filter may also be disposed within the imaging tube 406 so that the light path passes through the filter to select which wavelengths are employed in the formation of the image 404.

In a preferred embodiment, the system is adapted to analyze cow's milk to estimate the number of somatic cells per unit volume contained in the milk (the SCC). Such analysis is widely used to assess the health of cattle and the quality of their milk. This may be done using a reagent that is mixed with a milk sample and stains the somatic cells contained in the sample, which cells may be referred to as target cells, so that they will fluoresce when excited by light with a particular wavelength, or within a particular range of wavelengths, and the light source in the scope then may be adapted to generate light of that particular wavelength, or within that particular range of wavelengths. The reagent used may be propidium iodide, for which the particular wavelength is preferably in the range of about 500 nm to 570 nm, and more preferably about 535 nm. This results in fluorescence emission from the stained cells in the range of about 575 nm to 700 nm (mostly red), centered at about 617 nm. The stained target cells thereby are optically distinct from the remainder of the biological fluid, having a much greater brightness in the magnified image than the remainder of the sample in the red plane, or alternatively in a grayscale photograph captured by the camera. In this case, the scope 100 may be designed with a filter to allow the emitted light to pass through the filter, but not the transmitted light, such as a filter that passes light in the range of 575 nm to 700 nm.

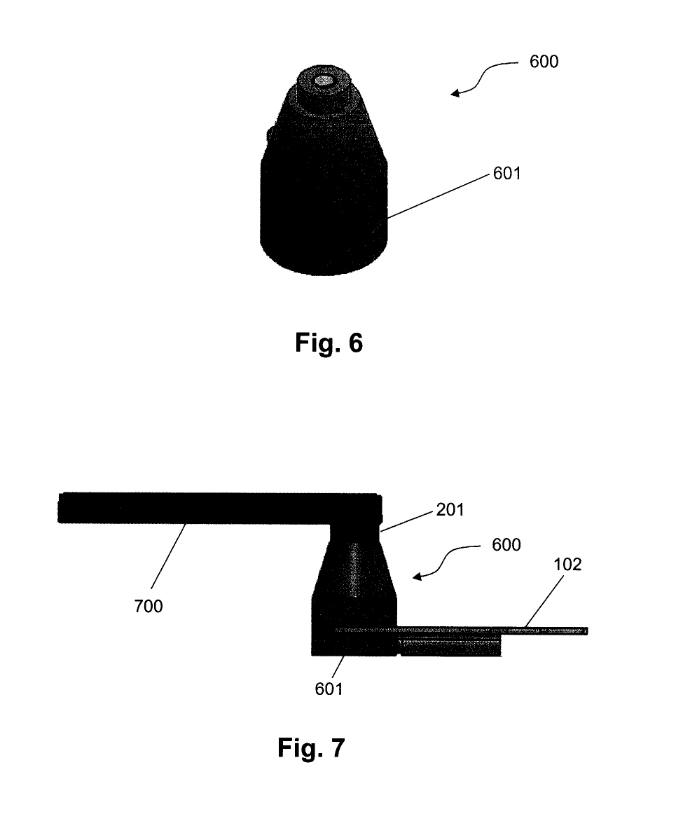

FIG. 6 shows another embodiment of a scope 600 having a slot 601 for receiving a sample slide 102, and FIG. 7 shows that embodiment of a scope 600 connected to a case 700 via the scope connector 201 that is mated with the case connector of the scope 600, with a slide 102 positioned in the slot 601 of the scope 600.

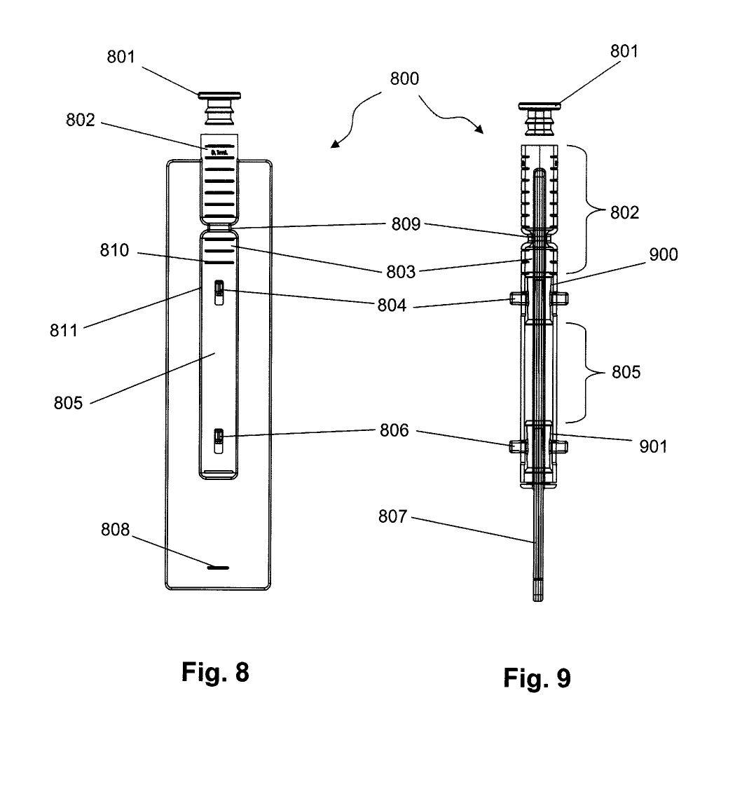

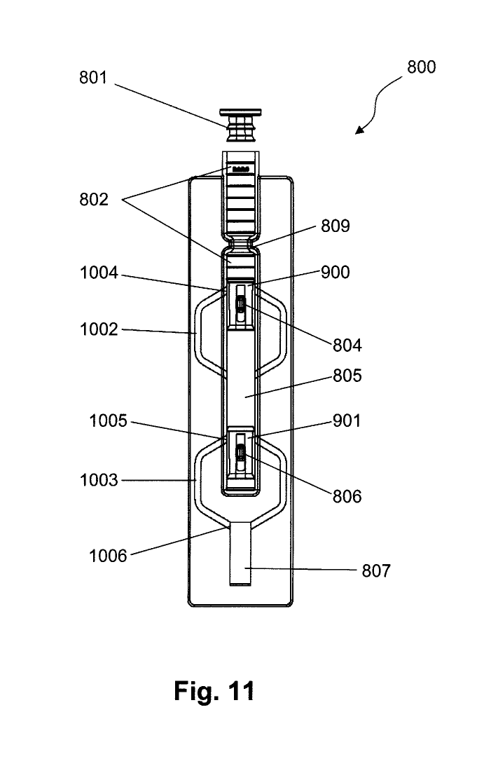

FIGS. 8 and 9 show a front and side view respectively of an embodiment of a sample slide 800. FIG. 11 is another front view where the internal structure of the slide 800 is shown. The normal orientation of a slide is as shown in FIG. 8, with the upper chamber 802 and cap 801 at the top, and the viewing chamber 807 and narrow slot 808 towards the bottom. When terms relating to orientation are used herein, it is to be assumed that the slide 800 is in the depicted vertical position.

The slide 800 is typically about 2.5 cm wide and 10 cm long. The slide has a hollow vertical cylindrical portion 811, the upper part of which forms a cylindrical upper chamber 802, or sample reception chamber, into which a cap 801 may be removably inserted, for receiving and holding a sample of biological fluid. The outside of the upper chamber 802 may have horizontal lines 810 drawn at intervals of 1 ml, for example, for measuring the amount of fluid in the upper chamber 802. The upper chamber 802 may also have a pinch point 809, or constriction, of reduced diameter positioned so that a fixed volume of fluid, such as 3 ml, can be held within the upper chamber 802 below the pinch point 809, although this is not essential. Such a pinch point 809 may allow the fixed amount of fluid to flow into the lower portion of the upper chamber 802 below the pinch point 809, but then allow the user to quickly pour off any fluid above the pinch point 809, while the constriction 809 prevents any significant amount of the fluid below that point from escaping. This provides a simple and effective way to ensure that the sample is a fixed amount of biological fluid. A cap 801 may be inserted if it is desired, for example, to retain the sample in the upper chamber 802 for a period before analyzing it. This may be useful, for example, to allow the sample to reach a particular temperature, such as by bringing a slide 800 containing a sample into an environment with the desired temperature and allowing the slide to remain in that environment until the temperature of the sample equalizes with the ambient temperature of the environment.

The cylindrical portion 811 need not be cylindrical and could, for example, have an oval or polygonal lateral cross section. The term “cylindrical” as used herein should be construed to include such variants. It is also not essential that the lateral cross-section of the cylinder have the same size or diameter all all points, except to the extent this is required for the portions in which the sliders slide in embodiments that employ sliders as valves.

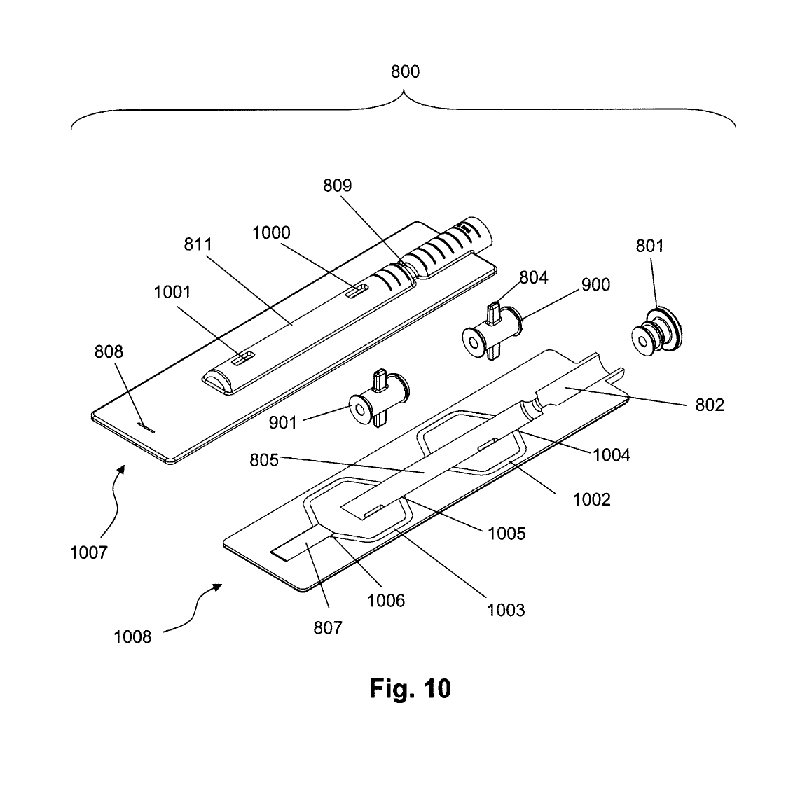

The bottom of the upper chamber 802 is formed by the top end of the upper slider 900, or valve, which can best be seen in FIG. 10, disposed within the cylindrical portion 811 of the slide 800 between the upper chamber 802 and mixing chamber 805. The upper slider 900 has a thumb button 804 that extends through an upper slot 1000 in the cylindrical portion 811 of the slide 800. The slot 1000 allows the slider 900 to move up in the cylinder 811 only to the point where the top of the slider 900 is located at the designated bottom of the upper chamber 802, which is above the top connection points 1004 of the upper channels 1002 with the cylinder 811, and constitutes the initial position of the upper slider 900. This is the closed position in which the upper chamber 802 and mixing chamber 805 are not in fluid communication.

The upper slider 900 may be biased into this position by a biasing mechanism, or may simply rely on a frictional connection with the inner surface of the cylinder 811. The upper channels 1002 are capillary type tubes, typically no more than about 2 mm in diameter, and preferably no more than about 1 mm in diameter, which are initially blocked by the upper slider 900, and which upper channels 1002 fluidly connect the upper chamber 802 with the mixing chamber 805 when the slider 900 is moved into the open position by moving it downward.

The mixing chamber 805 is the portion of the cylinder 811 between the bottom end of the upper slider 900 and the top end of a second lower slider 901, or valve, located towards the bottom of the cylinder 811.The lower slider 901 also has a thumb button 806 that extends through a second lower slot 1001. As with the upper slider, the lower slider is initially positioned at the top end of the range afforded by the slot 1001, which positions it to block access of any fluid in the mixing chamber 805 to a second pair of lower channels 1003, which are similar to the upper channels 1002. The upper slot 1000 allows the upper slider 900 to be slid down by a distance sufficient to expose the upper openings 1004 of the upper channels 1002 to the upper chamber 802, which is the open position, causing any fluid present in the upper chamber 802 to be drawn by gravity and capillary action through the upper channels 1002 and into the mixing chamber 805, and also allows exchange of air with the outside and equalization of the pressure. The mixing chamber 805 may be preloaded with a reagent, for example, so that the sample may then be mixed with the reagent. The user may close the upper channels 1002 by pushing the upper slider 900 back upwards, so that the mixing chamber 805 is sealed between the upper end of the lower slider 901 and the lower end of the upper slider 900. While the fluid is in the mixing chamber 805, the user may shake or invert the slide 800 a number of times to mix the sample with any reagent in the mixing chamber 805.

The mixing chamber 805 is sufficiently large to hold the sample and reagent with some additional space for mixing. For example, the sample may be 3 ml, the reagent 1 ml, and the mixing chamber capacity 6 ml. The mixing chamber 805 is sufficiently large that any air pressure force created by the movement of one of the sliders within the restricted range allowed by the slots 1000, 1001 does not cause movement of the other slider.

After the sample has been mixed with reagent, the user may push the lower slider 901 downward using the thumb button 806 on the slider 901 so that the upper openings 1005 of the lower channels 1003 are opened to the mixing chamber 805. The lower openings 1006 of the lower channels 1003 connect to a transparent viewing chamber 807, which has a narrow slot 808 that allows equalization of air pressure but does not allow any of the sample to escape because of surface tension. The mixed sample is drawn into the viewing chamber 807 by gravity and capillary action when the user pushes the lower slider 901 downward, and is maintained in the viewing chamber 807 because surface tension at the openings 1006 prevents the fluid in the viewing chamber 807 from re-entering the lower channels 1003.

The viewing chamber 807 has a volume of less than the required sample size for a given application so that the viewing chamber 807 is completely filled by a portion of the mixed sample. The viewing chamber 807 preferably has a uniform thickness, which is relatively small, e.g. preferably no more than 0.25 mm, and more preferably no more than 0.1 mm, to optimize it for use with generating an image that can be analyzed to assess characteristics of the sample. For this purpose, it is generally advantageous that it have a uniform thickness that is thin enough to reduce the occurrence of overlapping portions of the sample that may make the accurate measurement of a particular characteristic difficult or inaccurate. For example, when the characteristic is the number of somatic cells per unit volume in milk, it is desirable that the viewing chamber 807 be thin enough that, at the resolution of the camera, given the magnification of the scope, relatively few cells overlap.

The mixing chamber may be preloaded with any stains or reagents required for a particular application. With the sliders 900, 901 in the initial position, so that the thumb buttons 804, 806 are at the top-most points in the slots 1000, 1001 so that the sliders 900, 901 block the respective upper openings 1004, 1005 of the upper and lower channels 1002, 1003, the mixing chamber 805 is isolated from the outside environment and the stain or regent may be stored in the mixing chamber 805 for extended period of time. The reagent may include one or more stabilizers.

A slide may be manufactured using a transparent plastic material. A slide may be assembled from a back portion 1008, front portion 1007, upper slider 900 and lower slider 901, as depicted in FIG. 10. The sliders are sized to fit snugly in the cylinder 811 and, for example, are inserted in the back portion 1008 with one of the thumb buttons extending through a slot in the back portion 1008 identical to the slots 1000, 1001 in the front portion 1007.The front portion 1007 may then be placed on top of the back portion 1008 so that the other thumb buttons 804, 806 extend through the slots 1000, 1001 in the front portion 1007, and the front and back portions may then be bonded together to form a slide.

The slide is simpler and less expensive than other slides that have been developed for similar purposes. The use of gravity and capillary action rather than a vacuum results in an inexpensive disposable slide.

The software application is adapted to analyze a photograph of the magnified image of the sample of biological fluid in order to determine at least one optical characteristic of the sample. In the case of cow's milk stained with propidium iodide, one optical characteristic of the sample that is measured by the system may be an estimate of the total number of somatic cells in the image, which can be converted to an estimate of the number of somatic cells per unit volume of the sample based on the volume of the sample represented in the image, which is known from the interior depth of the viewing chamber (i.e. the interior width of the chamber along the light path) and the area of the viewing chamber represented by the magnified image.

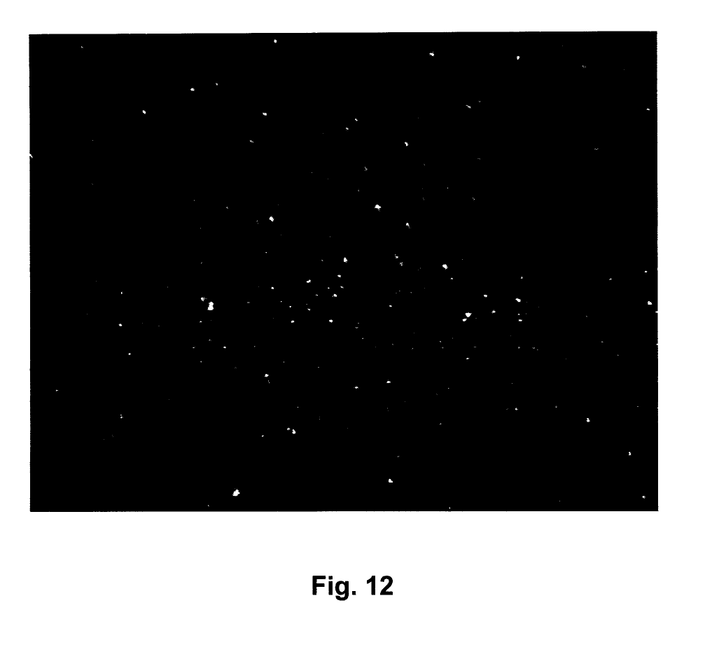

The software application is adapted to run on the portable computing device to analyze a photograph of the magnified image taken by the camera. An example of such a photograph is shown in FIG. 12. A photograph of the magnified image may be taken by the user of the device in the usual manner that photographs are taken using that particular device, and then the user can run the software application and instruct it to analyze the image. Alternatively, the software application can be designed so that it controls the camera so that it can instruct the camera to take a photograph of the image and then automatically proceed to analyze the image.

In the image (photograph), pixels that are part of a somatic cell are generally brighter than pixels not associated with a somatic cell. For a given configuration, a threshold can be determined so that pixels with a value greater than or equal to the threshold are considered to be part of a cell (“cell pixels”), and pixels with a value less than the threshold are not considered to be part of a cell (“non-cell pixels”). For example, a thresholding operation can be applied to the image to set all cell pixels to the value 1, and all non-cell pixels to the value 0. A connected region in the resulting binary image (a connected region being a group of cell pixels such that each cell pixel in the connected region is adjacent to at least one other cell pixel in the connected region) then represents a somatic cell or a number of overlapping or adjacent somatic cells.. Such connected regions are also often referred to as connected components or blobs.

Algorithms to identify connected regions and to identify the perimeters of the connected regions in an image are well known. Connected regions may have “holes”, being connected groups of one or more non-cell pixels such that no members of the group are connected to other non-cell pixels outside of the perimeter of the connected region.

In a simple embodiment, the software application may find and count the number of cell pixels in the perimeter of each connected region in turn, removing each connected region from the image after it has been found and the perimeter identified and counted. The cell count is initially set to zero. Based on historical analysis of visually inspected samples, a minimum perimeter length can be established so that any connected regions with a perimeter less than the minimum are not counted. Otherwise, the connected region is counted as a cell, and the cell count is incremented by one. After all regions have been analyzed, the resulting cell count provides an estimate of the number of somatic cells in the sample. The software application then further extrapolates the number of somatic cells per unit volume of biological fluid based on an estimate of the volume of milk imaged in the magnified image.

Also based on historical analysis of visually inspected samples, a second minimum perimeter length can be established so that any connected regions with a perimeter greater than the second minimum length are identified as macrophage cells and a second count of the number of macrophage cells may be made. Such a count may be more directly relevant to the assessment of the presence of mastitis than the count of all somatic cells. This is based on the fact that macrophage cells are known to be larger than other types of somatic cells normally found in a milk sample.

Alternatively, the somatic cell count may be estimated by calculating the total area of all connected regions in the image having an area or perimeter greater than a pre-defined minimum value. This total can then be divided by an estimate of the average number of cell pixels for a somatic cell, which number can be determined by calibrating the number so that the somatic cell count thereby calculated equals the cell count estimated by visual inspection, or other high-resolution method, on average over a reasonable number of samples (such as at least 100 samples).

Rather than using a thresholding algorithm, a more sophisticated algorithm may be used in order to achieve more accurate results. For example, segmentation may be performed directly on grayscale pixel values using a watershed algorithm.

Generally, a computer, computer system, computing device, client or server, as will be well understood by a person skilled in the art, includes one or more computer processors, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.). Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to the processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell the invention or parts thereof.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention as will be evident to those skilled in the art.

Where, in this document, a list of items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the items, and alternatives to the items, in the list that a skilled person would understand would be suitable for the purpose that the items are listed.

The word “transparent” as used herein with respect to the viewing chamber means that a significant proportion of light reflected from or transmitted by the sample in the viewing chamber passes though the surface of the viewing chamber at the end of the light path. In preferred embodiments, the portion of the slide covering the chamber on the side facing the imaging tube is clear glass or plastic so that 90% or more of the light passes through the slide. In embodiments that are backlighted, such as the embodiment depicted in FIG. 5, both the front and back sides of the viewing chamber are transparent. “Translucent” has the same meaning as “transparent” herein.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description as a whole.

1. A system for measuring optical characteristics of a biological fluid using a portable computing device having an integral camera, the camera having a lens, a sample of biological fluid being contained in a transparent viewing chamber in a sample slide, the system comprising:
(a) a scope comprising:
(i) an imaging tube having proximal and distal ends and having a slide holder adapted to receive the sample slide so that the viewing chamber is maintained inside the imaging tube, the imaging tube defining a light path between the viewing chamber and a viewing opening in the proximal end of the imaging tube;
(ii) a light source adapted to illuminate the sample of biological fluid in the viewing chamber when the sample slide is in the slide holder;
(iii) a lens system disposed inside the imaging tube, positioned to receive light reflected or transmitted along the light path by the sample of biological fluid contained in the viewing chamber, and adapted to present a magnified image of a portion of the sample of biological fluid at the viewing opening, the lens system comprising an ocular lens mounted in the imaging tube towards the proximal end of the imaging tube, and an objective lens mounted in the imaging tube between the viewing chamber and the ocular lens so that the viewing chamber is in a focal plane of the objective lens; and
(iv) a case connector;
(b) a case for attaching to the portable computing device, the case comprising a lens opening positioned to expose the camera lens when the case is attached to the portable computing device, and comprising a scope connector adapted to mate with the case connector on the scope to maintain the scope in a fixed position relative to the portable computing device so that the magnified image at the viewing opening is presented to the camera lens through the lens opening; and
(c) a software application adapted to run on the portable computing device and adapted to analyze a photograph of the magnified image taken by the camera to determine at least one optical characteristic of the sample.

2. The system of claim 1 wherein the scope connector surrounds the lens opening.

3. The system of claim 2 wherein the case connector is at the proximal end of the imaging tube, and the scope connector and case connector have circular cross-sections.

4. The system of claim 3 wherein the scope connector and case connector are threaded.

5-6. (canceled)

7. The system of claim 1 wherein the slide holder comprises a slot in the imaging tube oriented perpendicularly with respect to the light path.

8-11. (canceled)

12. The system of claim 1 wherein the biological fluid is milk, and the viewing chamber contains the sample of milk mixed with a reagent that causes somatic cells contained in the sample to fluoresce when excited by light with a particular wavelength, and wherein the light source is adapted to generate light of that particular wavelength.

13. The system of claim 12 wherein the reagent is propidium iodide and the particular wavelength is in the range of 500 nm to 570 nm.

14. The system of claim 13 wherein the particular wavelength is about 535 nm.

15. The system of claim 12 in which the optical characteristic measured by the system is an estimated number of somatic cells in the magnified image of the imaged portion of the milk sample.

16-17. (canceled)

18. The system of claim 1 wherein the light source is attached to the tube near the distal end inside the tube and the slide holder is located between the light source and the lens system.

19-35. (canceled)

36. A system configured to present an image representing a biological fluid to a portable computing device including a display and a camera assembly, the system comprising:
a scope comprising:
a viewing opening at one end of the scope;
a slot proximate an end of the scope distal to the viewing opening, the slot configured to receive a slide comprising a mixture of the biological fluid and a reagent;
a light source configured to illuminate the mixture;
a lens system configured to create a magnified image of at least a portion of the mixture; and
a case configured to receive and support the portable computing device in a predefined position with respect to the scope, the case comprising:
a lens opening positioned to expose the viewing opening to a camera lens of the camera assembly when the portable computing device is positioned within the case.

37. The system of claim 36, wherein the mixture is configured to cause stained somatic cells therein to fluoresce in response to the light source, the system further comprising a filter configured to pass light fluoresced by the stained somatic cells.

38. The system of claim 37, wherein the slot is configured to receive the slide at a focal plane of the lens system.

39. The system of claim 38, wherein the lens system comprises an ocular lens mounted in the scope towards the viewing opening, and an objective lens mounted in the imaging tube between the slot and the ocular lens; and wherein the slot is configured to receive the slide in a focal plane of the objective lens.

40. The system of claim 37, wherein the scope further comprises a second filter configured to block light of a particular wavelength from the light source.

41. The system of claim 40, wherein the in the range of 0 to 500 nm and 600 to 1000 nm.

42. The system of claim 36, wherein the biological fluid includes cow's milk.

43. The system of claim 42, wherein the reagent is propidium iodide.

44. The system of claim 43, wherein the light fluoresced by the biological fluid has a wavelength in the range of 500 nm to 570 nm.

45. The system of claim 44, wherein the light fluoresced by the biological fluid has a wavelength of about 535 nm.

46. The system of claim 36, wherein the slot is configured to orient the slide perpendicular to a path of light from the light source.

47. The system of claim 36, wherein the scope further comprises a case connector and the case further comprises a scope connector configured to rigidly connect to the case connector.

48. The system of claim 47, wherein the scope connector and the case connector have circular cross-sections.

49. The system of claim 48, wherein the scope connector and case connector are threaded.

50. A computer readable medium having stored thereon instructions for analysing an image of a mixture of a biological fluid and a reagent, the image comprising fluoresced cells within the mixture, the instructions when executed by a processor cause the processor to:
compare pixel values in the image with a pixel threshold;
identify pixels having a value greater than the pixel threshold as cell pixels;
identify and count a number of cell pixels in a perimeter of connected cell pixels;
count each set of connected cell pixels as one or more target cells based on the length of the perimeter of the set of connected cell pixels wherein a set of connected cell pixels having a perimeter length less than a predetermined number of pixels is not counted as a target cell;
estimate a number of target cells per unit volume based on the count of target cells and an estimate of the volume of the biological fluid in the image; and
output the number of target cells per unit volume.
